(19) United States
(12) Patent Application Publication
(10) Pub. No.: US 2008/0284163 A1
(43) Pub. Date: Nov. 20, 2008

(54) Connector for flexible tubing

(75) Inventors: Stephen P. Proulx, Boxboro, MA (US); Joseph Cianciolo, Hudson, NH (US); Brian Pereira, Salem, NH (US); James Vigna, North Andover, MA (US)

Correspondence Address: MILLIPORE CORPORATION, 290 CONCORD ROAD, BILLERICA, MA, 01821, US

(73) Assignee: Millipore Corporation, Billerica, MA (US)

(21) Appl. No.: 12/082,370

(22) Filed: Apr. 10, 2008

Related U.S. Application Data
(60) Provisional application No. 61/066,761, filed on Feb. 22, 2008.
(60) Provisional application No. 60/930,203, filed on May 15, 2007.

(51) Int. Cl. F16L 33/00

(52) U.S. Cl. 285/243; 285/242; 24/16 R

(57) ABSTRACT

A connector is provided for connecting a flexible conduit with a second conduit having a barbed outer surface. The connector accommodates the end of the flexible conduit and the end of the second conduit in a manner which prevents removal of the flexible conduit and the second conduit from the connector. Optionally, the connector has a ring that may be used to apply additional pressure and security to the outer surface of the flexible conduit. additionally, the connector may have a wireless enabled communication and optionally, memory device such as a RFID tag attached or affixed to it.

### CROSS-REFERENCE TO RELATED APPLICATIONS

This application claims the benefit of U.S. Provisional Patent Application No. 61/066,761, filed on Feb. 22, 2008 and U.S. Provisional Patent Application No. 60/930,203, filed on May 15, 2007, the entire contents of which are incorporated by reference herein.

### FIELD OF THE INVENTION

This invention relates to a connector for connecting flexible tubing to a barbed fitting.

### BACKGROUND OF THE INVENTION

Flexible tubing is widely utilized to deliver fluid from a fluid source to a storage site or fluid treatment site. The flexible tubing is connected to the storage volume or fluid treatment site in order to provide the desired fluid delivery. It is necessary to provide a secure and leak proof connection at the end of the flexible tubing in order to avoid fluid contamination and/or leakage. Such a secure connection is particularly required in medical and pharmaceutical applications such as blood pumps, oxygen concentration cartridges, filtration cartridges, intravenous bags or the like.

At the present time, cable ties are utilized to provide a secure connection at the end of the flexible tubing. These cable ties require a tool to tighten the cable tie around the end of the flexible tubing and to cut off the excess cable tie end after the desired tightening is effected. The exposed cut cable tie end is sharp and may cause damage to the storage area, such as a flexible bag or to the fluid treatment site.

U.S. Pat. Nos. 6,796,586 and 7,090,257 as well as patent application publication US 2005/0082826 disclose a lock clamp for flexible tubing. The clamp requires a cumbersome tool to connect the flexible tubing to a barbed fitting.

Accordingly, it would be desirable to provide a connector for connecting a flexible tubing to a barbed fitting which prevents leakage and/or contamination of fluid located within the flexible tubing. In addition, it would be desirable to provide such a connector which remains intact even at elevated fluid pressure within the flexible tubing. Furthermore, it would be desirable to provide such a connector which can be installed by hand without the use of a tool or unusually high hand strength while avoiding the creation of sharp edges. Such a connector would provide ease of installation as well as security against fluid leakage or fluid contamination.

### SUMMARY OF THE INVENTION

The present invention provides a connector to connect flexible tubing to a barbed fitting. The connector comprises an annular housing section having a size to accept an open end of a flexible conduit. Flexible fingers are positioned on an outer peripheral surface and/or an inner peripheral surface within the annular housing. The inner peripheral surface comprises one or more tabs. The tabs are sized to contact the step of a barb on a second conduit having an outer barbed surface. The second conduit is positioned within an opening formed by the inner peripheral surface (s) of the annular housing section. The fingers are sized to permit the flexible conduit to be positioned within the annular housing section and to apply pressure to the outside surface and/or inner surface of the flexible conduit. The barbed surface of the second conduit contacts the tab(s) when it is positioned within the opening of the connector. After connection of the flexible conduit to the second conduit is effected with the connector, removal of the flexible conduit from the connector is prevented by the fingers and removal of the second conduit from the connector is prevented by the tab(s).

In one aspect of this invention, a connector is provided having the annular housing section, the opening, the fingers and the tabs as set forth above and including a plate which exerts pressure on the outside surface of the flexible tubing, The plate can be formed in sections and can be formed integrally with the annular housing section or can comprise a separate piece which is joined to the annular housing section.

In another aspect of the present invention, if desired, the connector may be wireless enabled (such as RFID, Bluetooth® or Zigbee® devices) to help track the connector and/or the component to which it is attached.

### BRIEF DESCRIPTION OF THE DRAWINGS

FIG. 1 is a top perspective view of a connector of this invention.

FIG. 2 is a bottom perspective view of the connector of FIG. 1.

FIG. 3 is a cross sectional view of the connector of FIG. 1.

FIG. 4 is a perspective view of a barbed conduit.

FIG. 5 is a cross sectional view of the connector of FIGS. 1-3 with a flexible conduit and a barbed second conduit positioned within the connector.

FIG. 6 is a perspective view of an alternative connector of this invention.

FIG. 7 is a cross sectional view of the connector of FIG. 6 with a flexible conduit and a barbed second conduit positioned within the connector.

FIG. 8 is a top view of a connector of this invention having hinged plate sections.

FIG. 9 is a side view of the connectors of FIG. 8.

FIG. 10 is a side view of the connector of FIG. 9 having the plate sections closed.

FIG. 11 is a side partial cross sectional view of the connector of FIGS. 8, 9 and 10 positioned on a flexible conduit and on a barb and modified with an extended surface on the plate sections.

FIG. 12 is a side partial cross sectional view of an alternative embodiment of this invention having plate sections.

FIG. 13 is a cross sectional view of a two piece connector of this invention positioned on a flexible conduit.

FIG. 13a is a top-down cross sectional view of FIG. 13 along lines XX to XX.

FIG. 14 is a partial cross sectional view of an alternative configuration for a two piece connector of this invention.

FIG. 15 is a partial cross sectional view of an alternative configuration of a two piece connector of this invention.

### DESCRIPTION OF SPECIFIC EMBODIMENTS

The connector of this invention is provided with two or more fingers which contact a flexible conduit and which are sufficiently flexible to exert pressure on the flexible conduit when a force is exerted on the flexible conduit to remove the conduit from the connector. The pressure is sufficiently high as to retain the flexible conduit within the connector or to overcome the force exerted on the flexible conduit. The fingers are sufficiently flexible so as to pivot toward the flexible conduit when a pulling force is exerted on the flexible connector which tends to move the flexible conduit out of the connector. The connector of the invention also is provided with at least one tab which fits into the step portion of a barb positioned on the outside surface of a second conduit connected to the flexible conduit through the connector. The at least one tab is sufficiently flexible so that it overrides the barb and then is snap fit into the step at the underside of the barb. It is to be understood that flexible fingers also can be positioned on the tabs thereby to interact with the inner surface of the flexible conduit so as to assist in retaining the flexible conduit within the connector.

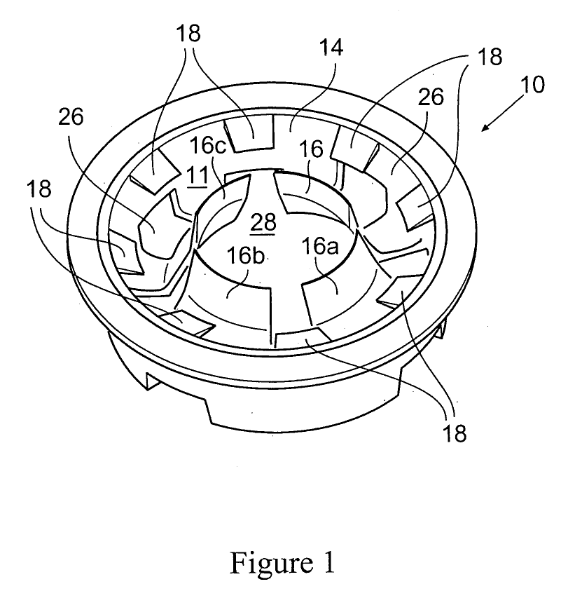

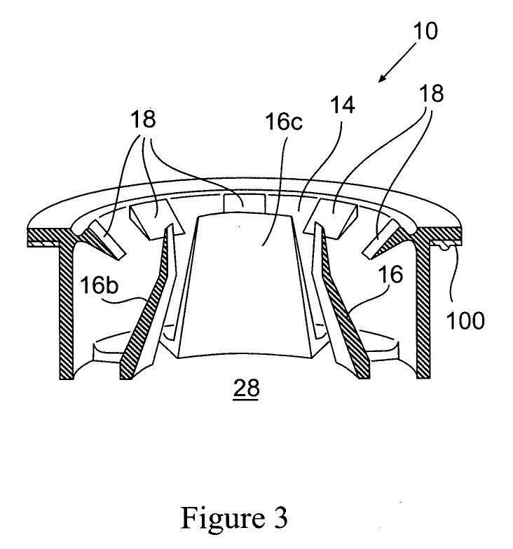

Referring to FIGS. 1, 2 and 3, the connector 10 of this invention includes an annular housing section 11 formed of outer peripheral wall 14 and the spaced apart plurality of tabs, 16, 16a, 16b and 16c. While the tabs are shown as four tabs, it is to be understood that any number of tabs can be utilized so long as they are sufficiently flexible as to override a barb positioned on the outside surface of a conduit and to snap into position into the step of the barb located at the bottom surface of the barb.

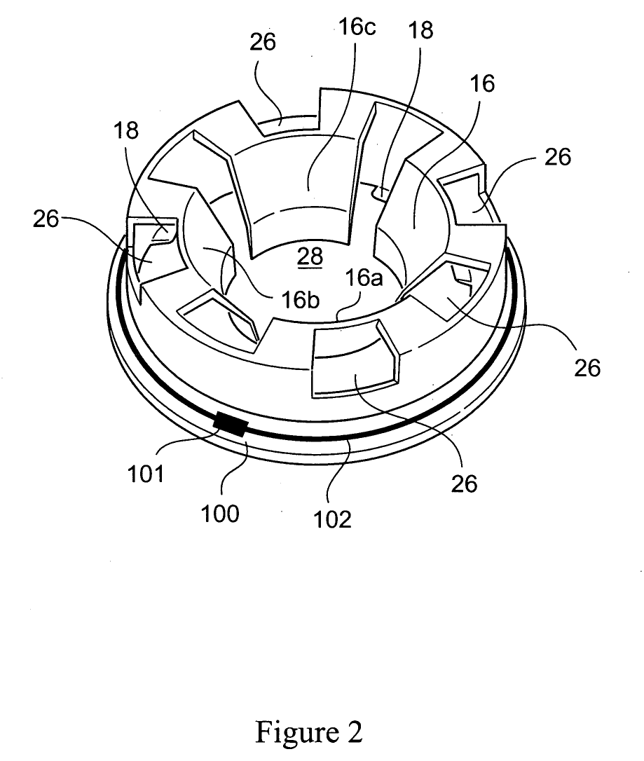

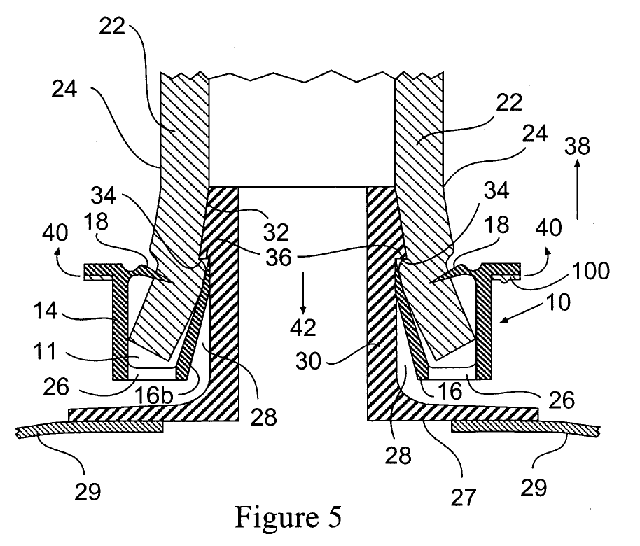

The fingers 18 are attached to the outer peripheral wall 14 and, preferably, extend inwardly from the wall 14 toward the bottom surface 20, (FIG. 2) so as to provide ease of positioning the end of a flexible conduit 22 (FIG. 5) into the annular section 11 of the connector 10. In addition, by extending the finger 18 downwardly, subsequent attempts to remove the flexible conduit 22 from the connector 10 are greatly diminished since the fingers 18 will flex toward the flexible conduit 22, thereby directly exerting pressure on the outside surface 24 of the flexible conduit 22 and thereby to cause the flexible conduit 22 to be retained within the connector 10. The fingers 18 can be the same length or different lengths. For example, when eight fingers 18 are employed every other finger can be the right length for a thin wall conduit and the others having an appropriate length for a thick wall conduit. Any number of fingers 18 can be used of one or more lengths so long as they are sufficient in number and length to grasp and hold the flexible conduit 22 as desired.

The connector 10 is optionally provided with spaced-apart openings 26 to increase the flexibility of the annular housing section 11 thereby to improve the ease of positioning the flexible conduit 22 into the connector 10. The hollow inner pathway 28 of the connector 10 is provided to permit the insertion of the second conduit 30 having the barb 32 having a step 34 and a bottom surface 36 (FIG. 5), into which tabs 16, 16a, 16b and 16c are positioned (FIGS. 1 and 5), and to allow for liquid or gas to pass between the flexible conduit 22 and the second conduit 30.

Optionally, the connector 10 may be wirelessly enabled as shown in FIG. 2 and other Figures described below. The wireless communications device 100 maybe a RFID tag having a communication and storage or memory component 101 and an antenna 102 as shown or other wireless devices such as Bluetooth® or Zigbee® wireless enabled communications devices.

By wirelessly enabling the connector 10 one can track the history of the connector and/or the component to which it is attached. For example, with a read only wireless device one can track the manufacture of the connector such as the lot number, date of manufacture and the like. With a read/write device containing an active memory, one can also add information to the wireless device such as when the connector was placed on the component, what the component is to which the device 100 is attached, what the component is meant to be used with, one or more trackable events that occur to the connector and the component to which it is attached such as sterilization, warehousing, use and the like.

Optionally, the wireless device may be gamma radiation stable such that the device is not damaged or destroyed due to the radiation typically used in many sterilization processes. Such devices are known as FRAM RFID and can have a storage component that employs a non-charge based storage mechanism such as a ferro-magnetic or magnetoresistive memory storage device.

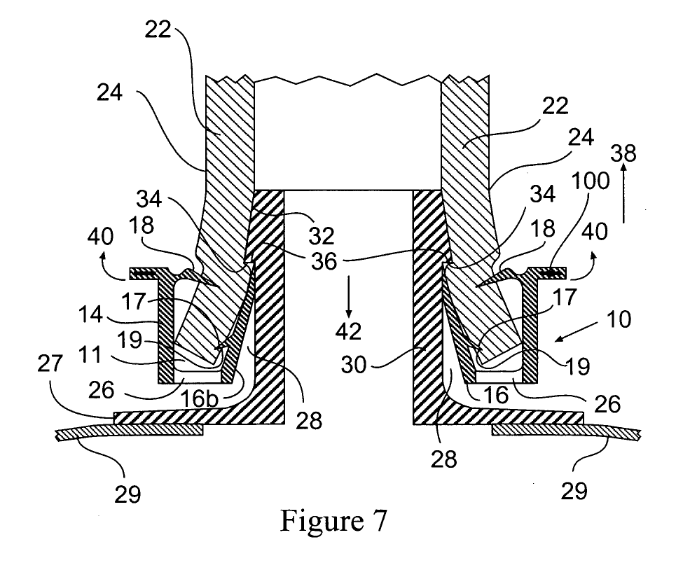

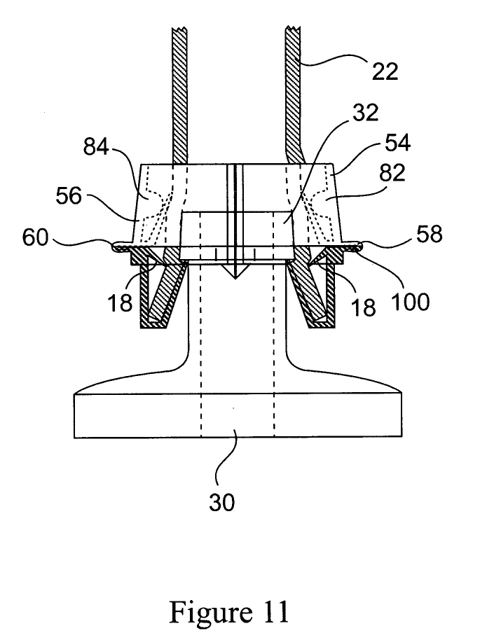

The wireless device 100 may attached to the connector by a mechanical device such as by a rivet or screw or a strap under a top surface of the connector and passing through two of the openings 26 and then to the wireless device (not shown) or it 100 can be molded into the connector 10 (as in FIGS. 7 and 11) or it 100 can be formed on or adhered to the surface of the connector 10 as shown in FIGS. 2, 3, 5 and 6.

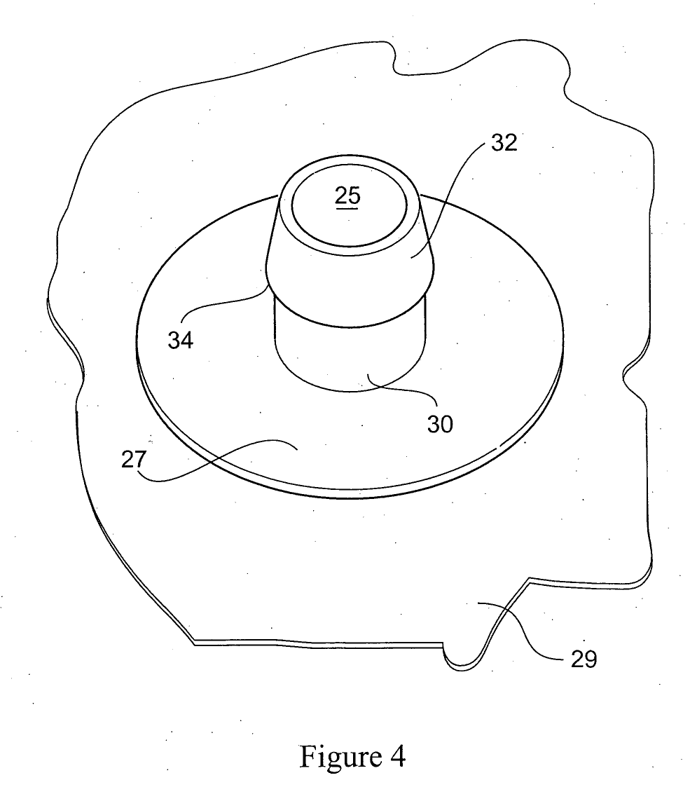

As shown in FIG. 4, a barbed second conduit 30 includes a barb 32 and an opening 25 that permits fluid flow therethrough. The conduit section 30 is attached to a flange 27 which, in turn, is attached to a fluid processor 29 which can retain fluid such as a bag or can effect a unit operation such as a filtration cartridge.

As shown in FIG. 5, the fingers 18 exert pressure on the outside surface 24 of flexible conduit 22. When a pulling force exemplified by arrow 38 is exerted on conduit 22, the fingers 18 pivot in the direction exemplified by arrows 40 thereby compressing the outside surface 24 of the flexible conduit 22, causing the flexible conduit 22 to be retained within the connector 10.

When a pulling force, as exemplified by arrow 42 is exerted on conduit 30, the tabs 16, 16a, 16b, and 16c exert a counter force on the bottom surface 36 of barb 32, thereby to effect retention of the conduit 30 in connector 10. Thus, the fingers 18 and tabs 16, 16a, 16b and 16c work in concert to retain the flexible conduit 22 and/or conduit 30 in the connector 10 when a pulling force is exerted on the flexible conduit 22 and top conduit 30. In addition, the positioning of conduit 22 and conduit 30 in connector 10 can be effected by hand without the need for a tool. Furthermore, the connector 10 can be sized to accept a wide size range of flexible conduits and second conduits having a barbed outer surface by providing a size range of connectors 10 having a variety of sizes of annular housing sections 11 and a variety of sizes of holes 28.

The conduit 22 has a flexibility sufficient to permit the fingers 18 to exert a pressure thereon when a force is exerted on the flexible conduit 22 in a direction to pull the flexible conduit 22 from the connector 10. Representative suitable flexible connectors can be made from silicone, preferably platinum cured silicone; polyethylene, propropylene; polyvinyl chloride; a thermoplastic elastomer; PTFE resin; EPDM, C-Flex® resin available from Consolidated Polymer Technologies of Clearwater Fla. or the like. The flexible tubing may also have a protective/pressure resistive braid over them or incorporated as a jacket onto them. Such braids are well known and can be made of polyester, polypropylene or stainless steel.

The barbed conduit 30 can be made of any material such as a polymeric composition, or a metal composition such as stainless steel so long as the tabs 16, 16a, 16b and 16c can be positioned on the bottom surface 36 of the barb 34 when the barbed conduit 30 is inserted in hole 28.

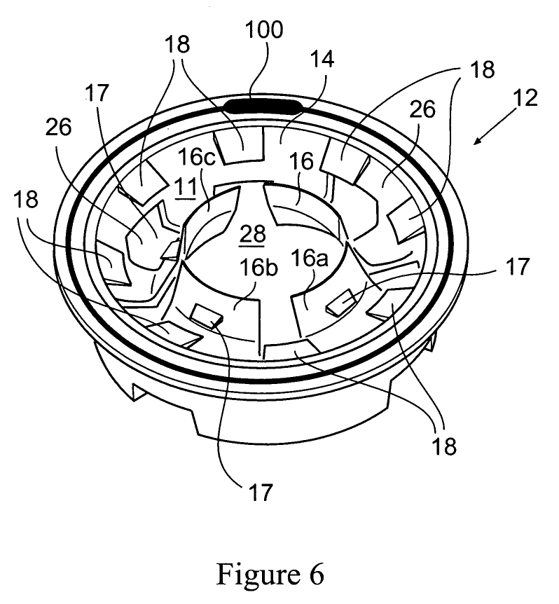

Referring to FIG. 6, an alternative connector 12 of this invention is shown. The connector 12 has the same elements of the connector 10 of FIG. 1 wherein like indicia identify like elements. The connector 12 includes a second set of fingers 17 which are positioned on the tabs 16, 16a, 16b and 16c. The fingers 17 function in the same manner as fingers 18 as described above. It is to be understood that the connector can be formed with only fingers 17, without fingers 18.

As shown in FIG. 7, the fingers 18 exert pressure on the outside surface 24 of flexible conduit 22 and the fingers 17 exert pressure on the inside surface 19 of flexible conduit 22. When a pulling force exemplified by arrow 38 is exerted on conduit 22, the fingers 17 and 18 pivot in the direction exemplified by arrows 40 thereby compressing the outside surface 24 and the inside surface 19 of the flexible conduit 22, causing the flexible conduit 22 to be retained within the connector 10.

When a pulling force, as exemplified by arrow 42 is exerted on conduit 30, the tabs 16, 16a, 16b, and 16c exert a counter force on the bottom surface 34 of barb 32, thereby to effect retention of the conduit 30 in connector 10. Thus, the fingers 17 and 18 and tabs 16, 16a, 16b and 16c work in concert to retain the flexible conduit 22 and/or conduit 30 in the connector 10 when a pulling force is exerted on the flexible conduit 22 and second conduit 30. The positioning of flexible conduit 22 and second conduit 30 in connector 10 can be effected by hand without the need for a tool. Furthermore, the connector 10 can be sized to accept a wide size range of flexible conduits and second conduits having a barbed outer surface by providing a size range of connectors 10 having a variety of sizes of annular housing sections 11 and a variety of sizes of holes 28.

Referring to FIGS. 5 and 7, in use, the barbed second conduit 30 is inserted into inner pathway 28 so that the barb 34 is positioned on the top of tabs 16a, 16b and 16c (FIGS. 1 and 6). The flexible conduit 22 then is inserted into annular housing section 11 to an extent such that its bottom end by-passes both sets of fingers 17 and 18. The flexible conduit 22 and second conduit 30 are thus retained within the connector 10 or 12 in the manner described above.

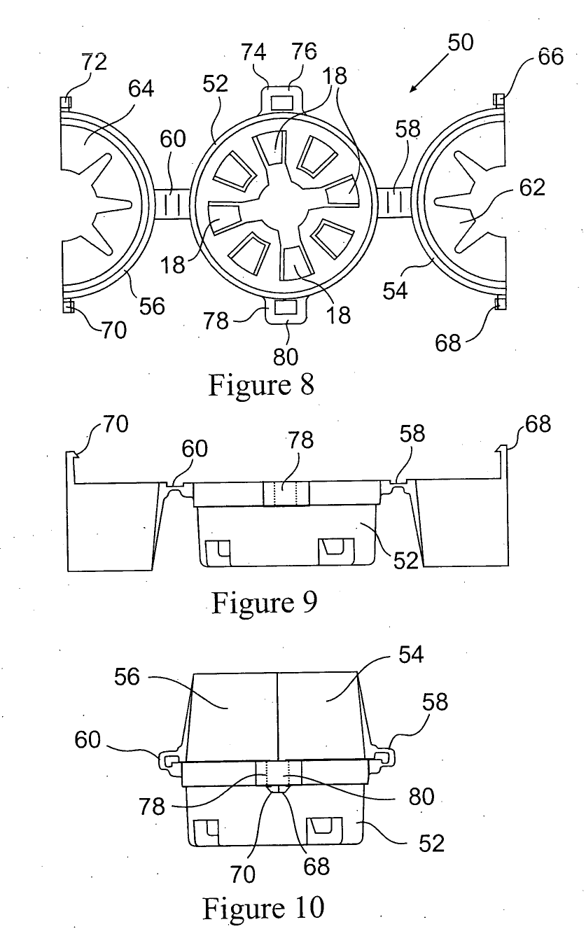

Referring to FIGS. 8, 9 and 10, a connector of this invention 50 includes a connector section 52 and two plate sections 54 and 56. The plate sections 54 and 56 are joined to connector section 52 by living hinges 58 and 60. The hinges 58 and 60 permit moving the plate sections 54 and 56 into locked contact with the connector section 52. After the flexible conduit such as flexible conduit 22 (FIG. 5) is positioned within the connector section 52 as described above with reference to FIG. 5, the plate sections 54 and 56 are pivoted about hinges 58 and 60. The hinges 58 and 60 function to expose the inner surface of the connector section 52 so that an end of a flexible conduit can be inserted therein. The hinges 58 and 60 also permit the plate sections 54 and 56 to be positioned in contact with an outside surface of a flexible conduit positioned within connector section 52 thereby to assist in preventing removal of the flexible conduit from the connector section 52. The plate sections 54 and 56 are locked into position against the outside surface of the flexible conduit 22 (FIG. 6) so that the inside surfaces 62 and 64 press against the outside surface 24 of conduit 22 (FIG. 5). It is to be understood that surfaces 62 and 64 can be smooth or rough such as serrated or having prongs extended there from to provide a gripping force on the flexible conduit. Locking is effected, for example, by means of tabs 66, 68, 70 and 72 which lock into the walls of openings 74, 76, 78 and 80. It is to be understood that locking of the plate sections 54 and 56 to connection section 52 can be effected by any conventional means. It is to be understood that more than two hinged plate sections can be utilized such as three or four plate sections. It is also to be understood that the plate sections 54 and 56 can be pivotally connected to the connector section 52 by any conventional means such as plastic ties which extend through openings shaped like openings 74, 76, 78 and 80.

As shown in FIG. 11, the connector of FIGS. 8, 9 and 10 can be modified so that the inside surfaces of the plate sections 54 and 56 include bead shaped extended surfaces 82 and 84. The purpose of the extended surfaces 82 and 84 is to exert a compressive force on flexible conduit 22 against barb 32.

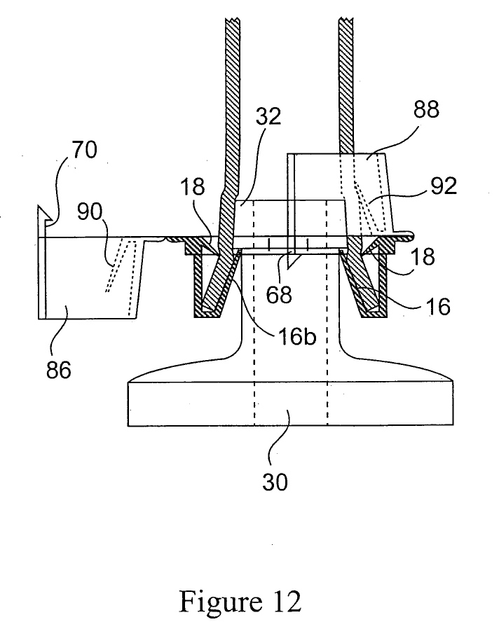

Referring to FIG. 12, one alternative connector of this invention is shown in position on a barbed conduit. The tabs 16 and 16b function in the same manner as described above with reference to FIGS. 1, 2 and 3. The plate sections 86 and 88 are provided with flexible caps 90 and 92. The flexible caps 90 and 92 provide flexibility for accommodating various sized flexible conduits that are positioned with the barbed conduit 30 in the manner described above (FIG. 5).

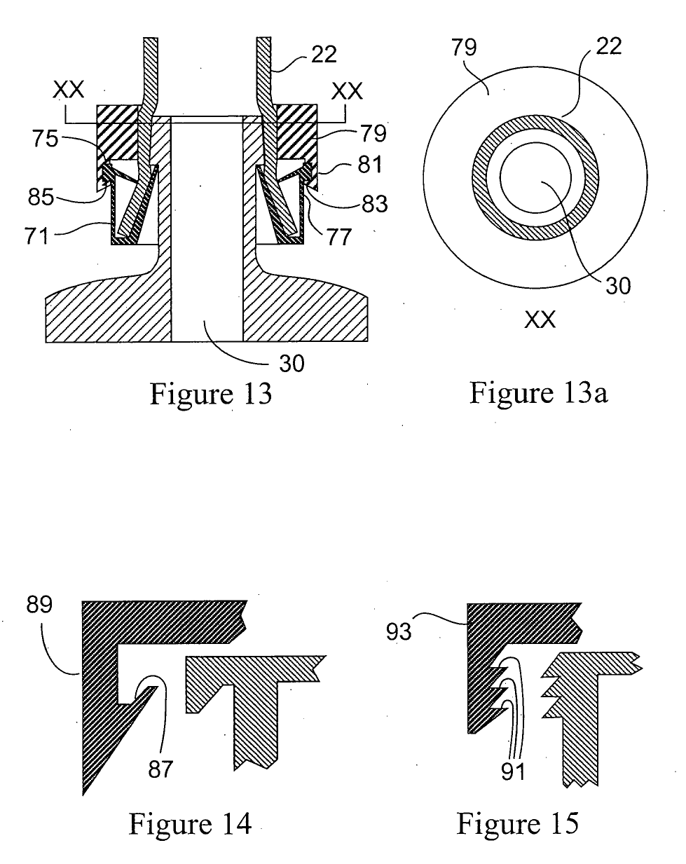

Referring to FIG. 13, a two piece connector of this invention is shown. The connector section 71 is the same as connector 10 (FIG. 1) except that it includes, on its outside surface a plurality of slots, at least two, preferably three or more, such as four slots 73 on its top surface 75 as shown. The slots 73 communicate with a circular path 77 that extends around at least a portion of the circumference of connector section 71. A second piece of this connector comprises a ring 79 which includes prongs 81 having a step 83 which fits below lip 85 of connector section 71. In use, the ring 79 is positioned on the flexible conduit 22. The end of the flexible conduit is placed in the connector section 71 in the manner described above with reference to connector 10 of FIG. 5. The ring 79 then is moved into the connector section 71 by positioning the prongs 81 into the slots 73 so that the steps 83 are positioned below lip 85. The ring 79 then is rotated in circular path 77 so that the ring 79 is prevented from separating from connector section 71 by the mating lip 85 and steps 83. It is to be understood that ring 79 and connector piece 71 can be connected to each other by any conventional means such as by being snap fit together or secured to each other with conventional mating helical paths.

As shown in FIG. 14, the steps on the prongs 89 can be angled. As shown in FIG. 15, a plurality of angled steps 91 can be utilized on each prong 93. Any geometry which promotes retention of the ring and connector section of the two piece connector of this invention can be utilized herein.

What is claimed:

1. A connector for a flexible conduit and a second conduit having a barbed outer surface, said connector having means for securing the second conduit within the connector by exerting a force on a bottom surface of the barbed outer surface and having means for exerting a compressive force on an outer surface of said flexible conduit.

2. A connector for a flexible conduit and a second conduit having a barbed outer surface, said connector having means for securing the conduit and the second conduit within the connector by exerting a force on a bottom surface of the barbed outer surface and having means for exerting a compressive force on an inner surface of said flexible conduit.

3. The connector of claim 1 which includes means for exerting a compressive force on an inner surface of said flexible conduits.

4. A connector for a flexible conduit and a second conduit having a barbed outer surface which comprises an annular housing section having an outer peripheral wall with an inner surface, a plurality of fingers on said inner surface, at least one tab positioned at an inner wall portion of said annular housing section, and an opening positioned within said at least one tab.

5. A connector system for transporting fluid between a flexible conduit and a second conduit having a barbed outer surface which comprises, a flexible conduit, the second conduit having a barbed outer surface and a connector for said flexible conduit and said second conduit having a barbed outer surface, said connector having means for securing the second conduit within the connector by exerting a force on a bottom surface of the barbed outer surface and having means for exerting a compressive force on an outer surface of said flexible conduit.

6. The connector system of claim 5 which includes means for exerting a compressive force on an inner surface of said flexible conduit.

7. A connector system for transporting fluid between a flexible conduit and a second conduit having a barbed outer surface which comprises, a flexible conduit, a second conduit having a barbed outer surface and a connector for said flexible conduit, said connector having means for securing the second conduit within the connector by exerting a force on a bottom surface of the barbed outer surface and having means for exerting a compressive force on an inner surface of said flexible conduit.

8. A connector system for transporting fluid between a flexible conduit and a second conduit having a barbed outer surface which comprises, a flexible conduit, a second conduit having a barbed outer surface and a connector for said flexible conduit and said second conduit having a barbed outer surface which connector comprises an annular housing section having an outer peripheral surface with an inner surface, a plurality of fingers on said inner surface, at least one tab positioned at an inner wall portion of said annular housing section, and an opening positioned within said at least one tab.

9. A connector system for transporting fluid between a flexible conduit and a second conduit which comprises a flexible conduit having a hollow inner pathway therethrough, a second conduit having a barbed outer surface with a step part and a bottom part, a flange portion adjacent the barbed outer surface and an opening between the flange and the farthermost portion of the barb, the second conduit barb portion being inserted within the inner hollow pathway of the flexible conduit, a connector for said flexible conduit and second conduit, the connector having a central annular opening through which the flexible conduit and barbed portion of the second conduit can be inserted, one or more flexible tabs outside of and adjacent to the central annular opening and capable of interacting with the step part and bottom part of the barbed section, and one or more fingers arranged outside of and adjacent to the one or more tabs to interact with the flexible conduit.

10. The connector of claim 9 wherein one or more fingers are capable of interacting with an outer surfaced of the flexible conduit.

11. The connector of claim 9 wherein the fingers extend from an outer surface of the one or ore tabs and the one or more fingers are capable of interacting with an inner surface of the flexible conduit.

12. A process of securing a flexible conduit to a second conduit comprising the steps of supplying a flexible conduit having an outer wall and an inner pathway therethrough, a second conduit having a flange portion and an outer barbed portion extending away from at least one side of the flange portion, the barbed portion having a step part and a bottom part, the second conduit having a first opening in the flange portion and a second opening in the barbed portion with a bore between the first and second openings, supplying a connector formed of a central opening having an inner diameter that is greater to or equal to the outer diameter of the flexible conduit, one or more flexible tabs arranged outside the one or more tabs, inserting the barbed portion of the second conduit into the inner pathway of the flexible conduit so as to cause the one or more tabs to interact with the barbed portion of the second conduit and the one or more fingers to interact with a surface of the flexible conduit to produce a strong seal between the second conduit, the connector and the flexible conduit.

13. The connector of claim 1 wherein said means for exerting a compressive force on an outer surface of said flexible conduit includes a detachable ring.

14. The connector of claim 1 wherein said means for exerting a compressive force on an outer surface of said flexible conduit includes hinged plate sections.

15. A connector for a flexible conduit and a second conduit having a barbed outer surface which comprises an annular housing section having an outer peripheral surface with an inner surface, a plurality of fingers on said inner surface, at least one tab positioned at an inner wall portion of said annular housing section, an opening positioned within said at least one tab and a ring that is attachable to said annular housing section.

16. A connector for a flexible conduit and a second conduit having a barbed outer surface which comprises an annular housing section having an outer peripheral surface with an inner surface, a plurality of fingers on said inner surface, at least one tab positioned at an inner wall portion of said annular housing section, an opening positioned within said at least one tab and plate sections attached to said housing section by hinges.

17. The connector system of claim 5 wherein said means for exerting compressive force on an outer surface of said flexible conduit includes a detachable ring.

18. The connector system of claim 5 wherein said means for exerting compressive force on an outer surface of said flexible conduit includes a hinged plate section.

19. The connector system of claim 7 wherein said connector includes a detachable ring capable of exerting a compressive force on an outer surface of said flexible conduit.

20. The connector system of claim 7 wherein said connector includes a hinged plate section capable of exerting a compressive force on an outer surface of said flexible conduit.

21. The process of claim 12 wherein said connector includes a detachable ring capable of exerting a compressive force on an outer surface of said flexible conduit.

22. The process of claim 12 wherein said connector includes a hinged plate section capable of exerting a compressive force on an outer surface of said flexible conduit.

23. The connector system of claim 8 wherein said connector includes a detachable ring capable of exerting a compressive force on an outer surface of said flexible conduit.

24. The connector system of claim 9 wherein said connector includes a detachable ring capable of exerting a compressive force on an outer surface of said flexible conduit.

25. The connector system of claim 10 wherein said connector includes a detachable ring capable of exerting a compressive force on an outer surface of said flexible conduit.

26. The connector system of claim 11 wherein said connector includes a detachable ring capable of exerting a compressive force on an outer surface of said flexible conduit.

27. The connector system of claim 8 wherein said connector includes a hinged plate section capable of exerting a compressive force on an outer surface of said flexible conduit.

28. The connector system of claim 9 wherein said connector includes a hinged plate section capable of exerting a compressive force on an outer surface of said flexible conduit.

29. The connector of claim 1 further comprising the connector has a wireless enabled communication and memory device.

30. The connector of claim 1 further comprising the connector has a wireless enabled communication and memory device and wherein the device is selected from the group consisting of RFID tags, Bluetooth devices and Zigbee devices.

31. The connector of claim 1 further comprising the connector has a wireless enabled communication and memory device attached to it by a means selected from the group consisting of mechanical, adhesive and thermal bonding means.

32. The connector of claim 1 further comprising the connector has a wireless enabled communication and memory device molded onto or into one of its surfaces.

33. The connector of claim 1 further comprising the connector has a wireless enabled communication and memory device that has read/write capability.

34. The connector of claim 1 further comprising the connector has a wireless enabled communication and memory device that has read/write capability and tracks one or more event that occur to the connector and/or a component to which it is connected.
